(19) United States
(12) Patent Application Publication
(10) Pub. No.: US 2024/0228211 A9
(43) Pub. Date: Jul. 11, 2024

(54) SHELVING SYSTEM WITH SINGLE PRODUCT PICK-UP AND NON-RETURNABLE MECHANISMS

(71) Applicant: PepsiCo, Inc., Purchase, NY (US)

(72) Inventor: Sandeep JAIN, Gurgaon (IN)

(21) Appl. No.: 18/490,603

(22) Filed: Oct. 19, 2023

(30) Foreign Application Priority Data
Oct. 20, 2022 (IN) 202241060155

(51) Int. Cl. B65H 9/10

(52) U.S. Cl. CPC B65H 9/10

(57) ABSTRACT

A cooler for storing and dispensing products is disclosed. The cooler includes a housing having an open access. A first glider and a second glider are disposed on a shelf interior of the housing, with a front end closer to the open access and a back end. The first and second gliders each has a partition and a pushing mechanism. The partition can prevent a user from reaching the products on both the first and second gliders at the same time with a single hand. The pushing mechanism can be adjustable between a locked condition to inhibit a movement of the products from the front end to the back end and a released condition to allow a movement of the products from the front end to the back end.

### FIELD

This disclosure generally relates to shelving systems for storing and dispensing products. More specifically, some embodiments described herein relate to shelving systems for unattended vending machines that restrict a consumer to pick up a single product with one hand and prevent a consumer from returning a product back to the shelving systems.

### BACKGROUND

In conventional shelving systems for product dispensing machines, such as a beverage dispensing cooler, products are aligned and displaced in columns for consumers to choose and pick from the front of the shelves. Plastic gliders may be mounted to the shelves as dividers to conveniently organize the products into columns. However, when gliders are placed closely side-by-side, consumers may be able to reach and pick products from different gliders at the same time with a single hand.

Conventional shelving systems also use pushing mechanisms to push the products aligned in columns to the very front of the shelves, allowing consumers to easily browse and choose products without reaching far into the product dispensing machine and also maintaining a uniformed display of the products. However, conventional pushing mechanisms allow consumers to return products back to the shelves by moving the pushing mechanisms in the backward direction. Allowing products to be returned to the shelf raises a risk of product tampering and vandalism.

### SUMMARY

Some embodiments of the disclosure provide a cooler for storing and dispensing products. The cooler can include a housing having an open access to an interior of the housing, a shelf disposed in the interior of the housing, and a first glider and a second glider. The first gilder and the second gilder can each have a front end and a back end and be disposed on the shelf with the front end closer to the open access. The first and second gliders can each have a base, a first sidewall, a second sidewall defining a space to receive and to align products in a column, a partition disposed on one of the first and second sidewalls, and a pushing mechanism disposed on the base. The partition can prevent a user from reaching the products on both the first and second gliders at the same time with a single hand. The pushing mechanism can push the products from the back end to the front end. The pushing mechanism can be adjustable between a locked condition, whereby the pushing mechanism inhibits a movement of the products from the front end to the back end, and a released condition, whereby the pushing mechanism allows a movement of the products from the front end to the back end.

In some embodiments, the partition has a front edge extending towards the front end and beyond the base of the glider and a top edge extending beyond a height of the products, such that a single hand cannot reach the products on both of the first and second gliders at the same time.

In some embodiments, the first and second gliders each includes a front bar across the first and second sidewall at the front end. The front bar can inhibit the products from leaving the glider at the front end. The partition includes a flange parallel to and above the front bar. The flange can inhibit the products from pivoting about the front bar.

In some embodiments, the first and second gliders each includes a front bar across the first and second sidewalls at the front end. The front bar can inhibit the products from leaving the glider at the front end. The partition includes a front bar cover to be fitly coupled onto the front bar.

In some embodiments, each of the first and second gliders further includes a second partition disposed on the other one of the first and second sidewalls.

In some embodiments, the first partition includes an alignment hole and the second partition includes an alignment pin. The alignment pin of the first glider can engage with the alignment hole of the second glider.

In some embodiments, each of the first and second gliders further includes a beam member disposed across the first and second partitions.

In some embodiments, the cooler further includes a camera disposed in the interior of the housing. The camera can record a side image of the products traveling through the open access. The partition can prevent a product obscuring another product in the side image.

In some embodiments, the partition is integral to the glider.

In some embodiments, the partition is removably coupled to the glider.

In some embodiments, the partition is snap fitted onto one of the first and second sidewalls.

In some embodiments, the cooler further includes a second shelf disposed above the first shelf, wherein a distance between a top edge of the pushing mechanism and the second shelf is less than a width of the products.

Some embodiments of the disclosure provide a cooler for storing and dispensing products. The cooler can include a housing having an open access to an interior of the housing, a camera disposed in the interior of the housing, a shelf disposed in the interior of the housing, and a first and a second glider. The first and second glider can each have a front end and a back end, and is disposed on the shelf with the front end closer to the open access. The first and second gliders can each have a base, a first sidewall, a second sidewall defining a space to receive and to align products in a column, and a partition disposed on one of the first and second sidewalls. The partition can have a front edge extending towards the front end and beyond the base and a top edge extending beyond a height of the products, such that a single hand cannot reach the products on both of the first and second gliders at the same time.

In some embodiments, each of the first and second gliders further includes a second partition disposed on the other one of the first and second sidewalls.

In some embodiments, each of the first and second gliders further includes a beam member disposed across the first and second partitions.

In some embodiments, the camera can record a side image of the products traveling through the open access, and the partition can prevent a product obscuring another product in the side image.

In some embodiments, the partition is integral to the glider.

In some embodiments, the partition is removably attached to the glider.

In some embodiments, the partition is snap fitted onto one of the first and second sidewalls.

In some embodiments, the glider further includes a pushing mechanism disposed on the base to constantly push the products from the back end to the front end. The pushing mechanism is adjustable between a locked condition, whereby the pushing mechanism inhibits a movement of the products from the front end to the back end, and a released condition, whereby the pushing mechanism allows a movement of the products from the front end to the back end.

### BRIEF DESCRIPTION OF THE FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a perspective view of a cooler with a single product pick-up shelving system according to some embodiments.

FIG. 2 is a top-down view of a shelving system with cameras capturing the image of products taken out of a cooler according to some embodiments.

FIG. 3 is a perspective view of a glider with single product pick-up mechanism according a first embodiment according to some embodiments.

FIG. 4 is a perspective view of a glider assembled into a shelving system according to some embodiments.

FIG. 5 is a perspective view of a glider assembled into a shelving system according to some embodiments.

FIG. 6 is a perspective view of a glider assembled into a shelving system according to some embodiments.

FIG. 7 is a perspective view of a pushing mechanism according to some embodiments.

FIG. 8 is a sectional perspective view of a pushing mechanism according to some embodiments.

FIG. 9 is a sectional perspective view of a pushing mechanism in locked condition restricting the return of products according to some embodiments.

FIG. 10 is a sectional perspective view of a pushing mechanism capable of automatically switching from locked condition to released condition according to some embodiments.

FIG. 11 is a sectional perspective view of a pushing mechanism capable of automatically switching from released condition to locked condition according to some embodiments.

FIGS. 12-13 are sectional perspective views of a pushing mechanism configured to be manually switched from locked condition to released condition according to some embodiments.

FIG. 14 is a sectional perspective view of a pushing mechanism configured to be manually switched from locked condition to released condition according to some embodiments.

FIG. 15 is a perspective view of a pushing mechanism with extended pusher board according to some embodiments.

### DETAILED DESCRIPTION

The present invention(s) will now be described in detail with reference to embodiments thereof as illustrated in the accompanying drawings. References to “one embodiment,” “an embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Product dispensing machines, such as a beverage cooler, provide consumers with access to various selections of products at retail level. Some dispensing machines may be located within a store, such that consumers choose and pick products from the dispensing machine and check out at store registries. Some dispensing machines may be unmanned vending machines, such that consumers make payments through the dispensing machine. Such unmanned vending machines may use vision technology to identify products taken out of the vending machine to facilitate the purchasing process.

In some dispensing machines, products may be aligned into columns on the shelves, and same type of product may be organized into a same column, with only the first product of the column visible from the front of the machine. In this way, the dispensing machine may display a maximum number of product selections for consumers to browse and choose from and also carry a sufficient stock for each type of product.

Plastic gliders with pre-defined column spaces may be mounted onto the shelf. The pre-defined column spaces may help more efficiently organize products on the shelf. Such plastic gliders may be placed at an angle with respect to the horizontal level, such that the front of the glider is lower than the back of the glider. In this way, products received within the glider may always gravitate towards the front of the glider. Alternatively, such plastic gliders may be placed horizontally and use pushing mechanisms for moving products received within the glider towards the front of the glider. For example, after a product at the very front of the glider is picked up by a consumer, the pushing mechanism may move the entire column of products towards the front, such that the product behind the picked-up product is aligned with the very front of the glider. In this way, because products are always pushed to the front of the dispensing machine, consumers may easily browse and pick products without the need for reaching far into the dispensing machine. In addition, a uniformed display of products creates an aesthetically pleasing appearance, indicating that the dispensing machine is fully stocked and well maintained.

However, existing conventional shelving systems have gliders that extend to only partial height of the products. Additionally, in order to carry a maximum number of product selections within a dispensing machine, the gliders are usually organized closely next to each other. As a result, consumers may easily touch or pick up two products from two adjacent gliders using a single hand, either intentionally or unintentionally. This situation may create a sanitary concern if consumers touch products that they do not intend to purchase. Additionally, picking up two products simultaneously with a single hand interferes with the vision technology used in some unmanned vending machines.

For example, machine readable marks are usually placed on the side of products, and a camera may be configured to capture side views of products being taken out of the vending machine. If a consumer picks two products side-by-side with a single hand, the machine readable marks on one product may be obscured by another product in the side view captured by the camera, thus the vision technology may not properly identify both products being taken out of the vending machine. Inaccurate identification of the products being taken out of the vending machine may cause income loss to the owner of the vending machine.

Moreover, existing pushing mechanisms allow not only a forward movement to push the products to the front but also a backward movement for reloading the glider with new products. Because of the backward movement, consumers are able to return a product back to the glider. This creates a similar sanitary concern and also a product tampering concern. Additionally, for the unmanned vending machine with vision technology, there is a risk of vandalism if consumers are allowed to freely return a product back to the shelf. The vision technology may be configured to identify products being taken out of the vending machine and products being returned back to the vending machine, and payments may not be processed for those returned products. However, it is possible that a consumer returns a dummy product to defraud the vision technology and therefore takes a product from the vending machine without paying.

Accordingly, there is a benefit to providing a single product pick-up mechanism to existing shelving systems that limits consumers to pick up only one product with a single hand. The single product pick-up mechanism may be effective in modifying current consumer behavior of grabbing multiple products from a shelf with single hand, but at the same time it may not unreasonably burden single product pick-up.

In one of the embodiments, the single product pick-up mechanism may be a vertical partition board between two columns of products. The partition board may include edges extending to the front and to the top. The partition board may prevent a single hand from simultaneously reaching to products on both sides of the partition board. In another embodiment, the single product pick-up mechanism may include flanges in front of products, such that it requires extra force to remove products from the shelf, and because of this extra force it is no longer feasible to pick up multiple products with single hand.

There is also a benefit to integrate this single product pick-up mechanism with existing gliders to reduce the amount of alternations to existing shelving systems and to ease the manufacturing processes. Accordingly, in some embodiments, the single product pick-up mechanism may be an attachment to existing gliders that can be easily fit and positioned onto the glider structure. In other embodiments, the single product pick-up mechanism may be an integral part of the glider structure.

There may also be a benefit to make existing pushing mechanisms non-returnable by restricting a backward movement. In some embodiments, the pushing mechanism may include a vertically moveable plunger that engages with recesses on the glider base to restrict the backward movement, and the plunger may be disengaged from the recesses to allow the backward movement only during a reloading process. In some embodiments, the plunger may be disengaged automatically when it reaches the front of the glider. In some other embodiments, a vending machine operator may manually disengage the plunger before reloading the glider.

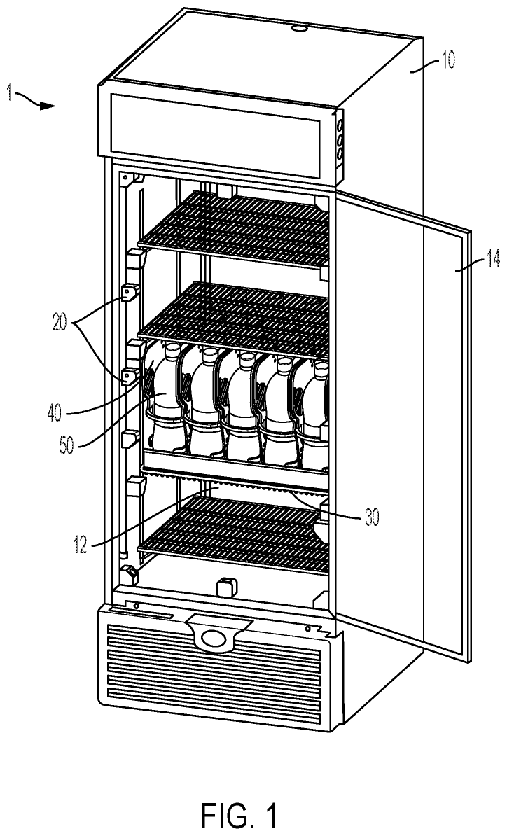

A vending machine 1, as shown in FIG. 1, may include a housing 10 and with an open access 12 to the interior of housing 10. In embodiments, vending machine 1 comprises an unmanned vending machine. The interior of housing 10 may have a temperature lower than the environment temperature. Housing 10 may further include a door 14 to close open access 12. A shelving system inside housing 10 may include one or more shelves 30 and one or more gliders 40. Products 50 may be placed on each of shelves 30 in columns, and gliders 40 may be mounted onto each of shelves 30 for receiving products 50 in columns. Products 50 may be ready to drink beverages packed in PET bottles or aluminum cans. Each of gliders 40 may be adapted to receive a different type of product 50. The vending machine 1 may include a single product pick-up mechanism to encourage consumer selection of products 50 one at a time.

The number of shelves 30 may be adjustable depending on the size of products 50 and the height of housing 10. The number of glider 40 may also be adjustable depending on the size of products 50 and the width of housing 10. In order to carry as many products 50 as possible, gliders 40 may be mounted closely next to each other.

Cameras 20 may be disposed on the frame of open access 12 and may be configured to capture the image of any product 50 that travels through open access 12. Cameras 20 may incorporate vision technology to identify the information associated with any product 50 that travels through open access 12. For example, products 50 may include machine readable marks that can be identified by vision technology to indicate the price of products 50.

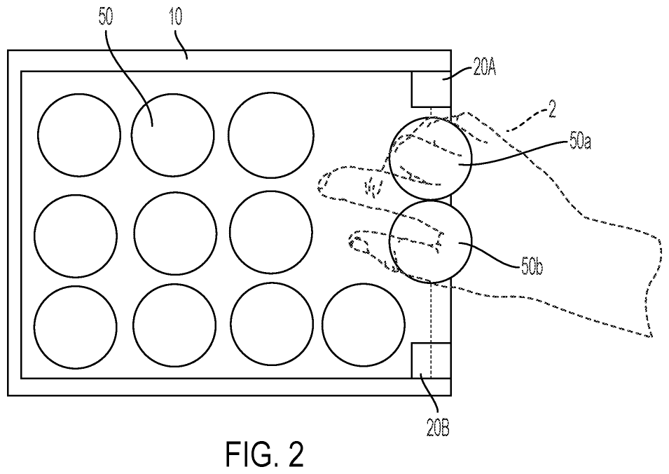

Cameras 20, however, may have limited views. When cameras 20 are placed in a middle location between two shelves 30, as shown in FIG. 1, they may only capture side views of products 50 that travels through open access 12. In cases where a consumer uses single hand 2 to grab two products 50A and 50B out of housing 10 at the same time, as shown in FIG. 2, the side views captured by cameras 20A and 20B may not properly show both products 50A and 50B. For example, the side view captured by camera 20A may only show product 50A, with product 50B hiding behind product 50A, and the side view captured by camera 20B may only show product 50B, with product 50A hiding behind product 50B. Because the images captured by cameras 20A and 20B may not properly show both products 50A and 50B, vision technology may not properly identify the identity of products 50A and 50B and thus fail to accurately calculate the payment due for this transaction.

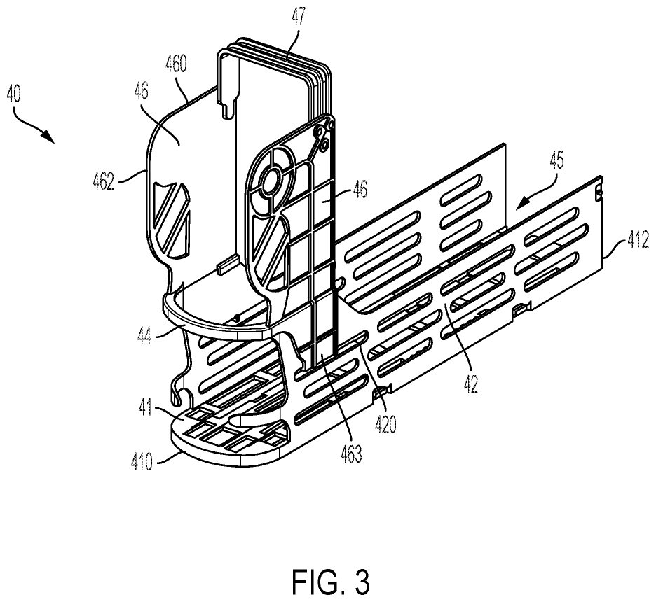

A single product pick-up mechanism may effectively reduce the incident shown in FIG. 2. Glider 40 with a single product pick-up mechanism according to one embodiment is shown in FIG. 3. Glider 40 may have a front end 410 and a back end 412. When mounted on shelf 30, front end 410 is placed closer to open access 12. Glider 40 may further include a base 41 and two side walls 42, defining a product space 45 for receiving products 50. Glider 40 may further include a front bar 44 for inhibiting products 50 from leaving glider 40 at front end 410. Front bar 44 may conform to the shape of products 50.

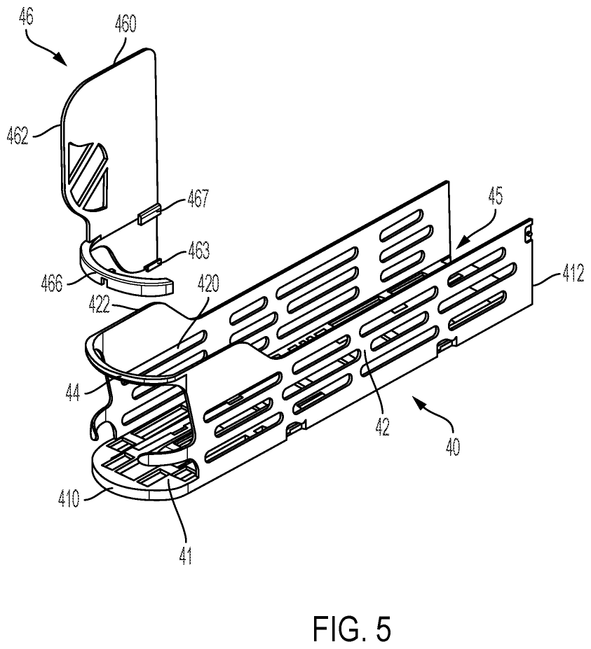

The single product pick-up mechanism may include a partition 46 on side wall 42. According to this embodiment, partition 46 may have a top edge 460 and a front edge 462, with top edge 460 extending beyond a height of products 50 and front edge 462 extending beyond front end 410. In some embodiments, as shown in FIG. 3, one glider 40 may include two partitions 46 mounted on each of side walls 42. In some other embodiments, as shown in FIG. 5, one glider 40 may include only one partition 46 mounted on one of side walls 42. In some embodiments, partition 46 may be an integral part of side wall 42. Alternatively, in some other embodiments, partition 46 may be removably attachable to side walls 42. For example, partition 46 may have a snap fit element 463 that engages with a snap fit recess 420 on side walls 42.

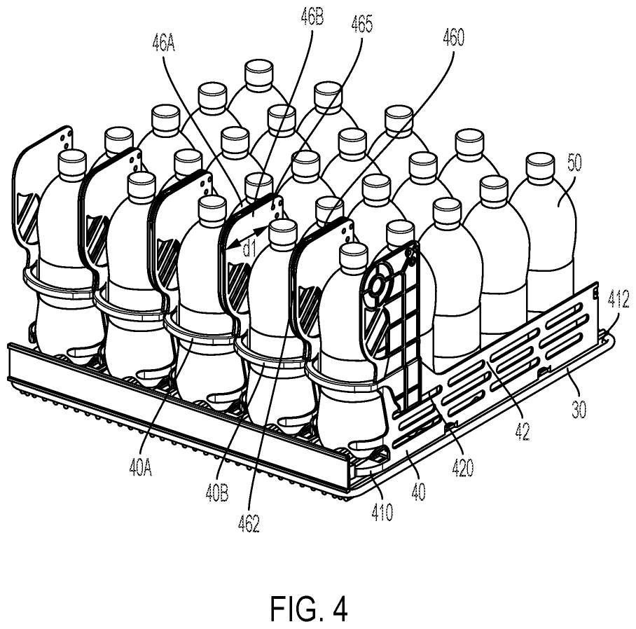

In some embodiments, as shown, for example, in FIG. 4, gliders 40 may include two partitions 46 assembled into a shelving system loaded with products 50. Gliders 40 are disposed on shelf 30 closely next to each other such that partition 46A on glider 40A is attached to partition 46B on glider 40B through connecting elements 465. Front edge 462 prevents the palm of a hand from reaching products 50 placed on glider 40A and glider 40B from front end 410 at the same time, and a distance d1 from front edge 462 to products 50 prevents the fingers of the hand from reaching products 50 placed on glider 40A and glider 40B at the same time. Distance d1 can vary based on various sizes of products 50 to prevent the fingers from reaching products 50. Distance d1 can also vary based on the average hand size or palm size of the local demographic. In some embodiments, distance d1 can be in a range of 5 mm to 10 mm, such as 6 mm to 9 mm, and such as 7 mm to 8 mm, Top edge 460 prevents a hand from inserting in between shelves 30 in order to reach to products 50 placed on glider 40A and glider 40B at the same time.

Partition 46 also requires sufficient structural stability to withstand a force exerted by a hand of a consumer, when assembled with glider 40. Accordingly, as shown in FIG. 5, partition 46 may include a front bar cover 466 that is configured to engage with front bar 44 of glider 40 in order to secure partition 46 in a lateral direction. Partition 46 may further include a support protrusion 467 that is configured to engage with a side wall edge 422 in order to secure partition 46 in a vertical direction. Both front bar cover 466 and support protrusion 467 may provide additional structural stability in additional to snap fit element 463. In embodiments where glider 40 include two partitions 46, as shown in FIG. 3, a beam member 47 may be provided across partitions 46. In this way, beam member 47 not only provides additional structural stability to partitions 46, it also serves as a handle to conveniently carry or transport glider 40. Alternatively, in some embodiments, partition 46 may be manufactured as an integral part of side wall 42, such that it is not necessary to include any additional elements for providing structural stability.

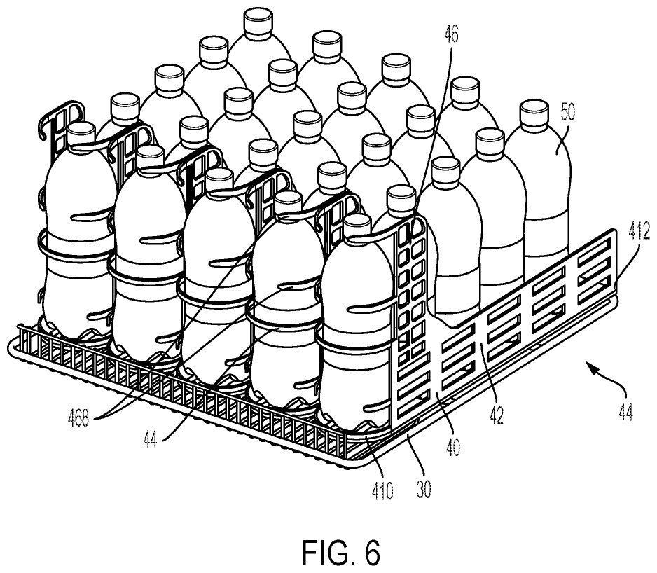

Another embodiment of a single product pick-up mechanism is shown in FIG. 6. According to this embodiment, each glider 40 may include two partitions 46 disposed on each of side walls 42, and each partition 46 may include a flange 468 that is located above front bar 44 and shaped parallel to front bar. Flange 468 may extend from partition 46 and does not connect with another flange 468 on the opposite side. In this way, flange 468 is deflectable and but requires additional force to grab product 50 by tipping it with respective to front bar 44. Therefore, even if a consumer is able to reach to products 50 on both sides of partition 46 with a single hand, it is difficult to pull both products 50 out of glider 40 with a single hand. The number of flange 468 on each partition 46 is adjustable depending on the desired inhibiting force. Beam member 47 may also be disposed across partitions 46 to provide additional structural support.

According to the embodiment shown in FIG. 6, partition 46 is an integral part of side wall 42. However, it is envisioned that in this embodiment partition 46 may also be removably attached the side wall 42 in the same way as described with respect to the embodiments shown in FIGS. 3-5 and may include snap fit element 463, front bar cover 466, or support protrusion 467.

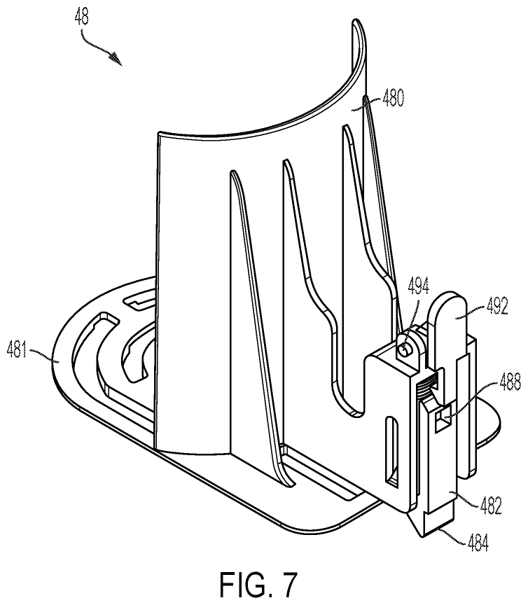

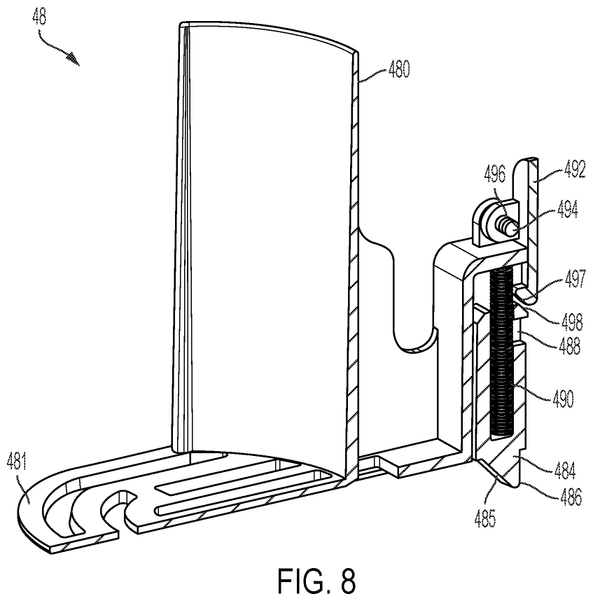

A non-returnable pushing mechanism 48 according to one embodiment is shown in FIGS. 7-8. Pushing mechanism 48 may be placed behind the last one of products 50 received in glider 40 and may include a pusher base 481 and a pusher board 480. Pusher base 481 is to be inserted between products 50 and glider base 41. Pusher board 480 is to be in contact with products 50 and for moving products 50 towards front end 410. Pusher board 480 may have curvature that conforms to the shape of products 50.

Behind pusher board 480, pushing mechanism 48 may further include a plunger 482 configured to move vertically and a compression spring 490 to bias plunger 482 to move downwards. Plunger 482 may include a tip 484 with a sloped side 485 closer to pusher board 480 and a vertical side 486 further away from pusher board 480. A snap lock lever 492 may be disposed on pushing mechanism 48 through a pin 494 and a torsion spring 496, such that snap lock lever 492 may rotate with respect to pin 494 and is biased in a vertical position parallel to plunger 482. When plunger 482 moves upwards to a top position, a surface 497 of plunger 482 engages with a surface 498 of snap lock lever 492 to rotate snap lock lever 492 to snap lock a top recess 488 of plunger 482 and inhibit plunger 482 from moving downwards.

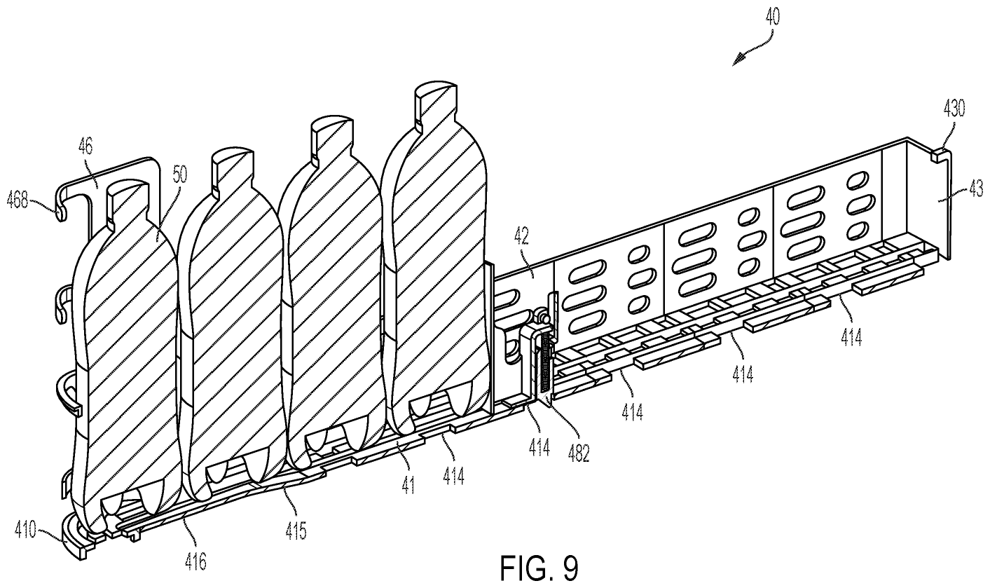

FIG. 9 shows pushing mechanism 48 in operation with glider 40. Glider 40 may be placed at an angle with respect to a horizontal level, such that products 50 and pushing mechanism 48 are gravitated to move towards front end 410 whenever a product 50 is taken out of glider 40. Alternatively, glider 40 may be placed at a horizontal level, and pushing mechanism 48 may be biased to move towards front end 410 by a spring (not shown). Glider base 41 may have multiple engaging slots 414 for receiving tip 484 of plunger 482. When pushing mechanism 48 is in a locked condition or a non-returnable condition, tip 484 engages with engaging slot 414, and vertical side 486 prevents tip 484 from leaving engaging slot 414 in a backward direction, while sloped side 485 allows tip 484 to leave engaging slot 414 in a forward direction.

When moving from one engaging slot 414 to another engaging slot 414 in a forward direction, plunger 482 moves upwards to a middle position where surface 497 and surface 498 do not engage with each other to activate snap lock lever 492. In this way, when plunger 482 reaches another engaging slot 414, tip 484 is again biased by compression spring 490 to engage with engaging slot 414 to prevent a backward movement. The distance between each engaging slots 414 may correspondence to a depth of products 50, such that when one product 50 is taken out of glider 40 at front end 410, plunger 482 moves forward to a next engaging slot 414 and pushes rest of products 50 to front end 410.

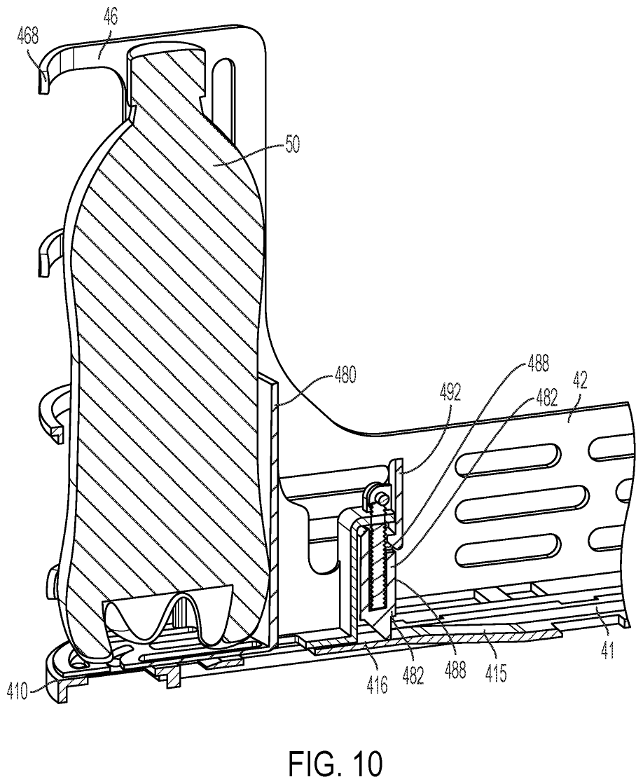

For pushing mechanism 48 to convert from the locked condition to a released condition or a returnable condition, such that glider 40 may be reloaded with new products 50, plunger 482 must move to the top position to activate snap lock lever 492. In some embodiments, in order to send plunger 482 to the top position, an elevation portion 416 may be connected to glider base 41 through a transition portion 415, as shown in FIG. 10. Elevation portion 416 is higher than glider base 41. As plunger 482 reaches elevation portion 416, it automatically moves to the top position for top recess 488 to engage with snap lock lever 492. Accordingly, the location of elevated portion 416 determines when pushing mechanism 48 automatically converts from the locked condition to the released condition. Elevation portion 416 may be provided at distance from front end 410 greater than a depth of product 50, such that pushing mechanism 48 converts to the released condition while the one last product 50 still remains on glider 40. Alternatively, elevation portion 416 may be provided at a distance from front end 410 less than a depth of product, such that pushing mechanism 48 converts to the released condition only after all products 50 are taken out of glider 40.

Once pushing mechanism 48 converts to the released condition, because top recess 488 is engaged with snap lock lever to inhibit a downward movement of plunger 482, it may remain in the released condition even if it leaves elevation portion 416, thus allowing glider 40 to be fully reloaded with products 50.

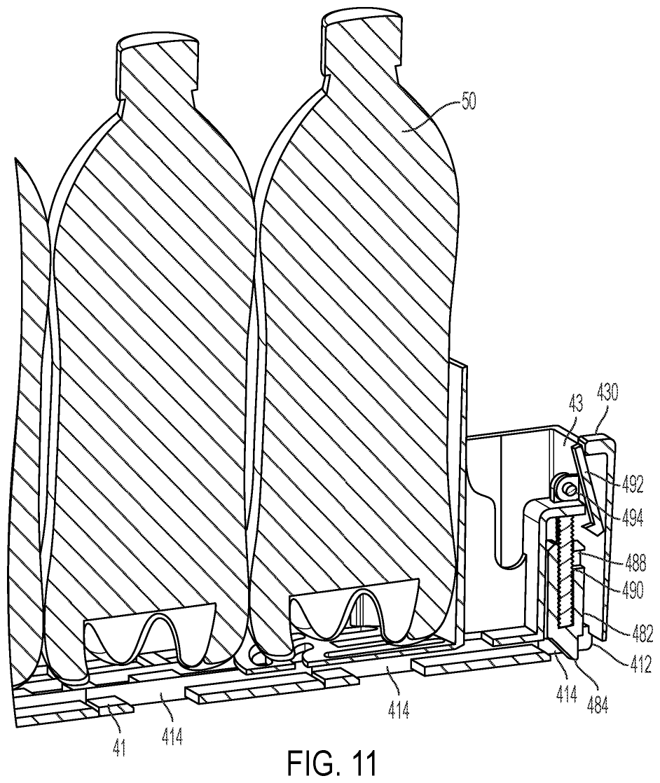

In order for pushing mechanism 40 to automatically convert back to the locked condition, a protrusion 430 may be provided on a rear wall 43, as shown in FIG. 11. When glider 40 is fully reloaded such that pushing mechanism 48 reaches back end 412, protrusion 430 is configured to rotate and disengage snap fit lever 492 from top recess 488, allowing plunger 482 to move downwards.

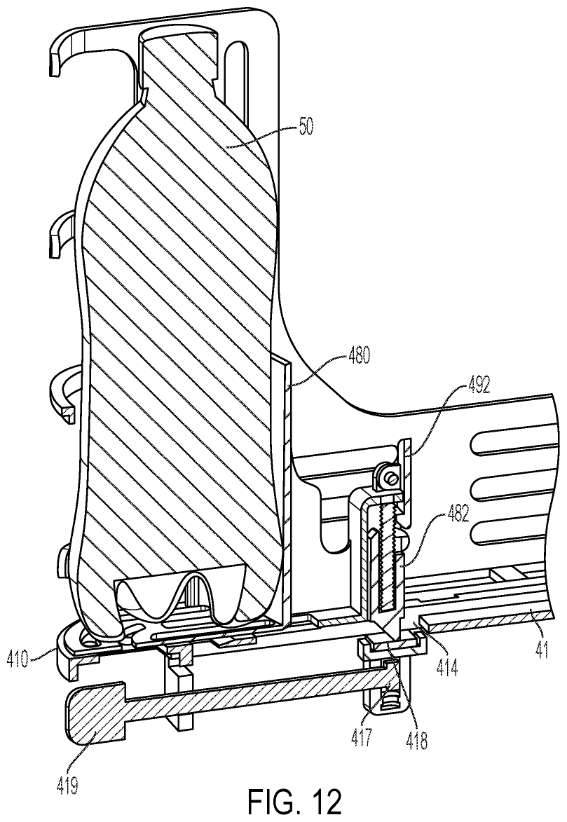

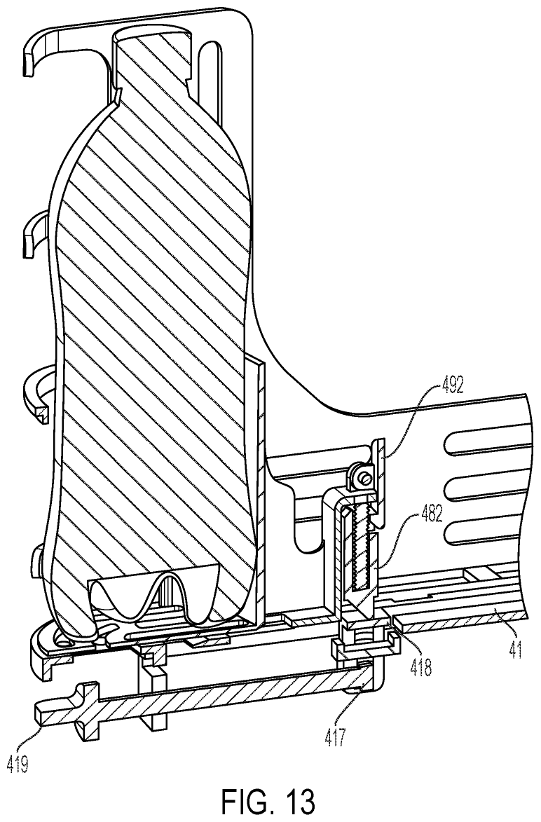

In some embodiments, it may be desirable to manually convert pushing mechanism 48 from the locked condition to the released condition because the owner or the operator of vending machine 1 may want to restrict the return of products 50 even if glider 40 is empty. An embodiment with manual conversion to released condition is shown in FIGS. 12-13. A moveable step 418 may be provided on glider base 41 for moving plunger 482 to the top position, and a rotary handle 419 may be configured to move moveable step 418. Rotary handle 419 may be connected to moveable step 418 through a rack and pinion mechanism 417. Moveable step 418 may be provided at the engaging slot 414 closest to front end 410.

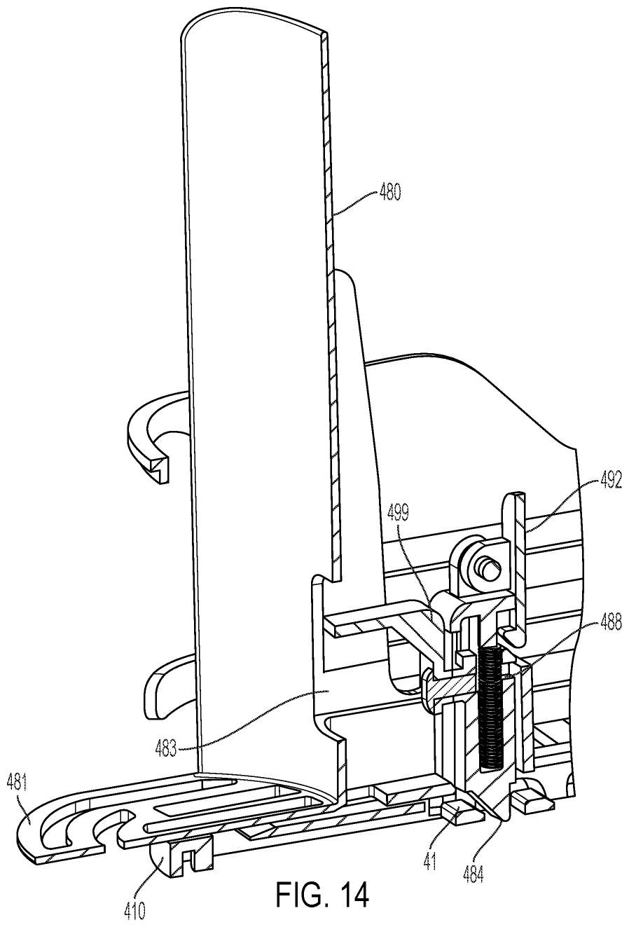

A second embodiment with manual conversion to released condition is shown in FIG. 14, where pushing mechanism 48 may include a lift handle 499 that is reachable from an opening 482 on pusher board 480. Lift handle 499 is connected to plunger 482 for moving plunger 482 to the top position.

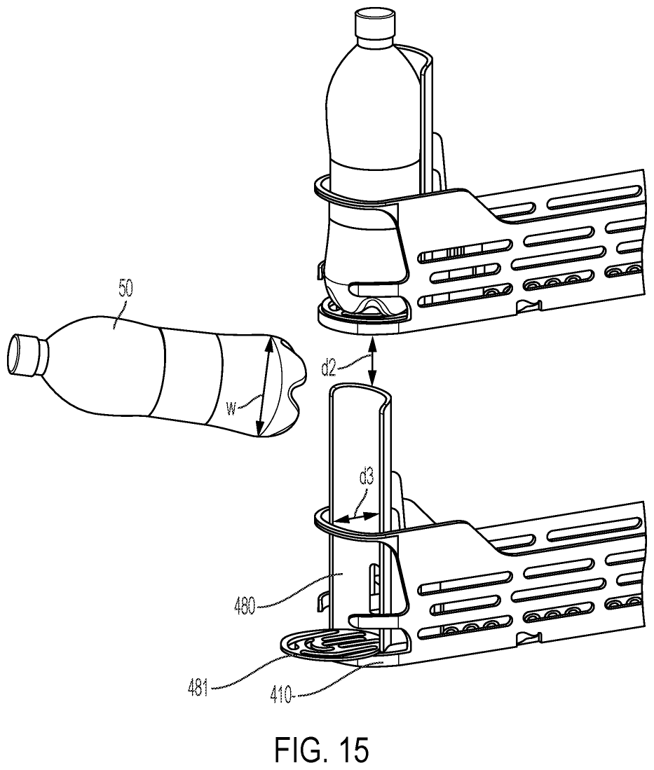

In some situations, it may be further desirable to restrict the return of products 50 to the back of pushing mechanism 48. Accordingly, as shown in FIG. 15, pusher board 480 may have an extended height, such that a space d2 above the top of pusher board 480 is less than a width w of product 50. In this way, product 50 may not be returned to the back of pusher board 480.

Also shown in FIG. 15, when pushing mechanism 48 is at the last engaging slot 414 closest to front end 410, a distance d3 between front bar 44 and pusher board 480 may be less than width w of product 50, such that product 50 may not be returned even when glider 40 is empty.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A cooler for storing and dispensing products, the cooler comprising:
a housing comprising an open access to an interior of the housing;
a shelf disposed in the interior of the housing; and
a first glider and a second glider each having a front end and a back end, disposed on the shelf with the front end closer to the open access,
wherein the first glider and the second glider each comprises:
a base, a first sidewall, and a second sidewall defining a space to receive and to align products in a column,
a partition disposed on one of the first sidewall and the second sidewall, configured to prevent a user from reaching the products on both the first glider and the second glider at the same time with a single hand, and
a pushing mechanism disposed on the base, configured to push the products from the back end to the front end,
wherein the pushing mechanism is adjustable between a locked condition, whereby the pushing mechanism inhibits a movement of the products from the front end to the back end, and a released condition, whereby the pushing mechanism allows a movement of the products from the front end to the back end.

2. The cooler of claim 1, wherein the partition comprises a front edge extending towards the front end and beyond the base of the glider and a top edge extending beyond a height of the products, such that a single hand cannot reach the products on both the first glider and the second glider at the same time.

3. The cooler of claim 1, wherein the first glider and the second glider each comprises a front bar across the first sidewall and the second sidewall at the front end, the front bar configured to inhibit the products from leaving the glider at the front end, and wherein the partition comprises a flange parallel to and above the front bar, the flange is configured to inhibit the products from pivoting about the front bar.

4. The cooler of claim 1, wherein the first glider and the second glider each comprises a front bar across the first sidewall and the second sidewall at the front end, the front bar configured to inhibit the products from leaving the glider at the front end, and wherein the partition comprises a front bar cover configured to be fitly coupled onto the front bar.

5. The cooler of claim 1, wherein each of the first glider and the second glider further comprises a second partition disposed on the other one of the first sidewall and the second sidewall.

6. The cooler of claim 5, wherein the first partition comprises an alignment hole and the second partition comprises an alignment pin, and wherein the alignment pin of the first glider is configured to engage with the alignment hole of the second glider.

7. The cooler of claim 5, wherein each of the first glider and the second glider further comprises a beam member disposed across the first partition and the second partition.

8. The cooler of claim 1, further comprising a camera disposed in the interior of the housing, camera configured to record a side image of the products traveling through the open access, wherein the partition is configured to prevent a product obscuring another product in the side image.

9. The cooler of claim 1, wherein the partition is integral to the glider.

10. The cooler of claim 1, wherein the partition is removably coupled to the glider.

11. The cooler of claim 10, wherein the partition is snap fitted onto one of the first sidewall and the second sidewall.

12. The cooler of claim 1, further comprising a second shelf disposed above the first shelf, wherein a distance between a top edge of the pushing mechanism and the second shelf is less than a width of the products.

13. A cooler for storing and dispensing products, the cooler comprising:
a housing comprising an open access to an interior of the housing;
a camera disposed in the interior of the housing;
a shelf disposed in the interior of the housing; and
a first glider and a second glider each having a front end and a back end, disposed on the shelf with the front end closer to the open access,
wherein the first glider and the second glider each comprises:
a base, a first sidewall, and a second sidewall, defining a space to receive and to align products in a column, and
a partition disposed on one of the first sidewall and the second sidewall and comprising a front edge extending towards the front end and beyond the base and a top edge extending beyond a height of the products, such that a single hand cannot reach the products on both of the first glider and the second glider at the same time.

14. The cooler of claim 13, wherein each of the first glider and the second glider further comprises a second partition disposed on the other one of the first sidewall and the second sidewall.

15. The cooler of claim 14, wherein each of the first glider and the second glider further comprises a beam member disposed across the first partition and the second partition.

16. The cooler of claim 13, wherein the camera is configured to record a side image of the products traveling through the open access, and wherein the partition is configured to prevent a product obscuring another product in the side image.

17. The cooler of claim 13, wherein the partition is integral to the glider.

18. The cooler of claim 13, wherein the partition is removably attached to the glider.

19. The cooler of claim 18, wherein the partition is snap fitted onto one of the first sidewall and the second sidewall.

20. The cooler of claim 18, wherein the glider further comprises a pushing mechanism disposed on the base configured to constantly push the products from the back end to the front end, and wherein the pushing mechanism is adjustable between a locked condition, whereby the pushing mechanism inhibits a movement of the products from the front end to the back end, and a released condition, whereby the pushing mechanism allows a movement of the products from the front end to the back end.
